(19) United States
(12) Patent Application Publication
(10) Pub. No.: US 2008/0018860 A1
(43) Pub. Date: Jan. 24, 2008

(54) System and method for 3D optical projection

(76) Inventor: Thomas Hennes, New York, NY (US)

Correspondence Address: DARBY & DARBY P.C., P.O. BOX 770, Church Street Station, New York, NY, 10008-0770, US

(21) Appl. No.: 11/490,942

(22) Filed: Jul. 21, 2006

(51) Int. Cl. G03B 21/00

(52) U.S. Cl. 353/7

(57) ABSTRACT

A method and apparatus for three-dimensionally projecting multiple images onto a centrally-located screen whereby viewers positioned circumferentially about the screen are each exposed to different images. The system comprising a projection screen and a plurality of viewing stations. Each viewing station includes a beamsplitter and first and second projectors each having a lens. The projectors are mounted such that their respective lenses are spaced a distance apart equal to an inter-ocular spacing and are configured to project images onto the projection screen. A mechanical apparatus is provided to optimize a quality of an image on the projection screen as seen by an observer looking at the beamsplitter.

### FIELD OF THE INVENTION

This invention relates to a stereoscopic image projection system using beamsplitters. More particularly, it relates to a method and apparatus for three-dimensionally projecting multiple images onto a centrally-located screen whereby viewers positioned circumferentially about the screen are each exposed to different images.

### BACKGROUND OF THE INVENTION

Optical projection systems can be configured to display multiple, different images to several observers, simultaneously. The observers are seated close together at fixed locations in order to simultaneously view respectively different images. However, to prevent the different projected images from interfering with each other, separate viewing volumes may be needed for each observer. Building separate viewing volumes for each observer can be an expensive undertaking.

Other optical projection systems have used beamsplitters to provide multiple images to multiple observers without the need for separate viewing volumes. One such system is disclosed in my U.S. Pat. No. 6,665,985, believed to be the closest prior art. In these systems, a lens-projector and beamsplitter combination is used and images are simultaneously displayed on a flat screen to spatially separated observers. Each observer is placed in a fixed position such that his or her eyes are placed at substantially the same reflected position as the projector lens in order to view a distortionless, bright image. Moreover, each observer is able to view a discrete image, which is not viewable by other observers, on the projection screen. In essence, the image viewed by any one individual observer at the optimum position appears sufficiently bright in contrast to the image viewed by other observers to “wash out” the other image, thus rendering it unable to cause interference with the image being specifically viewed by the individual observer. To view a distortionless, optically brilliant image, each observer must be at a specified or exact position to view the desired discrete visual information.

The system just described, while effective in some instances, could be improved. Firstly, the above described system cannot be used to immerse the observer in a stereoscopic scene. Secondly, when the position of the system components are fixed, the location of the observer's eyes must be positioned at a particular location to observe an image of optimal quality. Since observers have different heights, an observer may have to adjust his or her body to place his or her eyes at the optically correct position. This can result in an inconvenient viewing experience for the observers. Thirdly, there is a need for a projection system which allows several people located about a screen to view different 3D images depending on their viewing position. This ideal condition is difficult to realize when several people wish to view the picture simultaneously from varied locations, such as when the projection system is used in an exhibit or exhibition hall.

In an attempt to overcome the viewing limitations associated with conventional projection systems, the present invention provides a viewing system including a flat, convex, or concave screen. Projecting an image on convex and concave screens presents several problems, yet the invention addresses these and other problems.

### SUMMARY OF THE INVENTION

The present invention offers a different approach to conventional 3D image presentation by utilizing a concave or convex (preferably spherically curved) screen and advantageously permitting multiple observers to respectively view different 3D images displayed on a common projection screen. Observers of differing heights view clear and bright images without optical interference from other images being displayed at the same time. Moreover, the beamsplitter optical projection system embodiments can be easily installed at any desired location.

In one aspect, the invention is directed to an optical projection system comprising a convex projection screen and a plurality of viewing stations. Each viewing station includes a beamsplitter, first and second projectors each having a lens, wherein the first and second projectors are mounted such that their respective lenses are spaced a distance apart equal to an inter-ocular spacing, wherein the lenses are directed at the beamsplitter and the first and second projectors are configured to project images shot at an inter-ocular distance apart (i.e., at a distance from each other to reproduce the subject image seen by the left and right eye) onto the projection screen, and a mechanical apparatus adapted to optimize a quality of an image on the projection screen as seen by an observer looking at the second beamsplitter.

Alternatively, each viewing station can include a first and second beamsplitter and a first and second projector each including a respective lens. The first and second projectors are directed at the first beamsplitter and configured to project images onto the projection screen via the second beamsplitter, wherein the projected images are overlaid at a certain focal distance defined as the point of focus. The lenses of the first and second projectors must either be spaced an inter-ocular distance apart or the optical equivalent of the inter-ocular distance must be achieved using the first and second beamsplitters. In the latter arrangement, the projected images are spaced apart from each other a distance equal to an inter-ocular spacing even when the projector lens are not physically spaced at the inter-ocular spacing. A mechanical apparatus, such as a chair, headrest, handgrips or joystick, is adapted to optimize a quality of an image on the projection screen as seen by an observer looking at the second beamsplitter.

These and further aspects, features and advantages of the present invention will become more apparent from the following description when taken in connection with the accompanying drawings which show, for purposes of illustration only, several embodiments in accordance with the present invention.

### BRIEF DESCRIPTION OF THE DRAWINGS

The present invention is illustrated by way of example and not by way of limitation in the figures of the accompanying drawings in which like references indicate similar elements.

FIG. 1 is a front view of a particular projection system structured in accordance with the principals of the present invention;

FIG. 2 is a top plan view of the projection system of FIG. 1;

FIG. 3 is a cross-sectional view of one arrangement of the projection system corresponding to line B-B shown in FIG. 2;

FIG. 4 is a top view of the projection system corresponding to the line B-B shown in FIG. 2;

FIG. 5A is a side view of a spherical, retro-reflective screen in accordance with one aspect of the present invention;

FIG. 5B is a side view of spherical, reflective screen;

FIG. 6 is a cross-section view of a second arrangement of the projection system corresponding to line B-B shown in FIG. 2;

FIG. 7 is a top view of the projection system corresponding to the line B-B shown in FIG. 2;

FIG. 8 is a top view of a third arrangement of a projection system;

FIG. 9 is a top plan view of a projection system in accordance with the principles of the present invention; and

FIG. 10 is a top plan view of an alternative projection screen and projector arrangement for use with the present invention.

### DETAILED DESCRIPTION

The following description is presented to enable any person skilled in the art to make and use the invention, and is provided in the context of particular applications of the invention and their respective requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

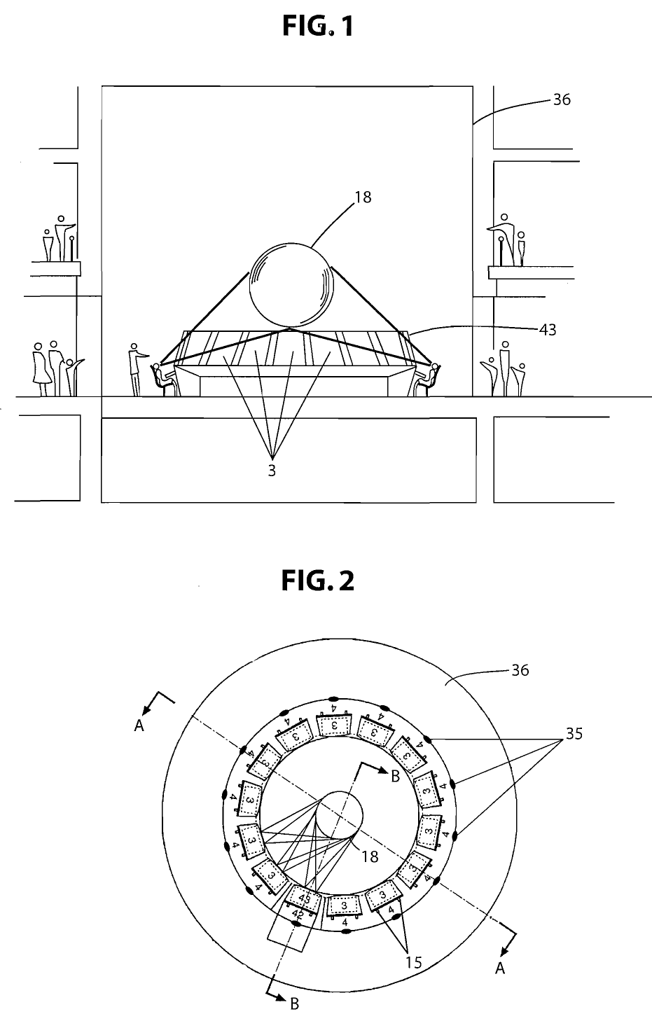

The embodiment of FIG. 1 in accordance with the present invention produces 3D images utilizing beamsplitters and a spherical, retro-reflective screen. A plurality of observers of various heights and handicaps can simultaneously view respectively different 3D images in a common space without interference from other images. The images (e.g., still photos, video images, etc.) are displayed on this common projection screen and are very bright and clear to the observers viewing them. Image discrepancies (e.g., distortion) caused by factors such as the angle formed by the optical axis of projection and/or the angle formed by the viewing axis can be automatically corrected when viewed using a curved screen by placing the viewer in a position where his or her eyes are in the same optical position as the projection lens. Placing the viewer in this optimal position is accomplished using beamsplitters and a mechanical apparatus which allows the viewer to adjust his vertical/horizontal position with respect to the projection system or vise versa as discussed further below. The optical geometry between a beamsplitter, a projector lens, and the observer's eyes can be adjusted using a mechanical apparatus so that a bright and clear image is viewable by the observer. Such an adjustment mechanism allows observers to adjust their viewing position so that their eyes are substantially at the same reflected position as the projection lens.

In the illustrated system, one or more separated or overlapping images are projected onto a common projection screen in such a way that individual observers or small groups of observers positioned at individual, spatially separated, interactive viewing stations are able to view projected 3D images specifically intended for their stations without optical interference from other images being projected. An observer can thus have an individualized viewing experience, while being in a common space with others having their own individualized viewing experiences.

In any particular viewing station, the 3D image viewed by an observer originates from two separate images, which in this embodiment has each image projected from a individual projector located at the observer's viewing station. The projectors include lens and are positioned such that their respective lens are spaced apart a distance equal to the ocular spacing of an average observer. The projectors preferably each simultaneously direct an image to a beamsplitter at each station and the beamsplitter reflects a portion of the image toward the retro-reflective projection screen. After receiving the images from each projector, the projection screen reflects the received images back through the beamsplitter and a resultant 3D image can be seen by the observer looking through the beamsplitter. Subsequently, when the images are reflected back through the beamsplitter only a portion of the light comprising the image passes through the beamsplitter to the observer's eyes and the remaining light is reflected back to the projector lenses as unusable light. The amount of unusable light reflected back to the projectors can be varied by altering the material properties of the beamsplitter employed, allowing a greater or smaller percentage of light to pass through and a greater or smaller percentage to get reflected. The observer can be seated, standing, or moving while viewing the 3D image on the projection screen by looking through the beamsplitter.

Each of the viewing stations may also have a mechanical apparatus and an audio system which can be controlled by the observer. In this regard, an observer may interact with his or her viewing station so that his or her viewing and listening experience is customized. As will be explained in more detail below, the mechanical apparatus can be used to optimize the optical geometry between the beamsplitter, projector lens, and the observer's eyes, e.g., by moving an observer (e.g., horizontally or vertically) at the viewing station to an optimum viewing position. The audio system provides audio information and/or music for the observer to hear while the observer views images at the viewing station. For example, a soundtrack can be played while the observer views preselected images, thus providing the observer with a multimedia experience. Audio output and/or other forms of interactive digital media can function in connection with the projected images increasing the observer's level of interaction with the system, e.g., gaming.

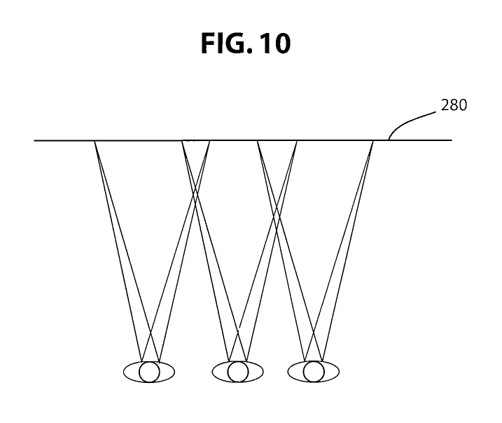

Referring now to FIGS. 1 and 2, a plurality of viewing stations 3, 43 (e.g., fourteen viewing stations in FIG. 2) are disposed in a viewing structure 36 such as an open platform or room. A plurality of observation stations are capable of providing different images on a common projection screen 18 at different stations while in a single common space. As is apparent from FIGS. 1 and 2, embodiments of the invention are especially useful as an attraction in, for example, an exhibition hall or an amusement structure in a theme park or other venue. However, embodiments can also be used in connection with flight simulators, virtual reality apparatuses, movie screenings or any suitable environment where projected images are viewed. Each viewing station 3, 43 also includes a position 4, 42 (FIG. 2) for observers to stand or sit. One or more viewing stations 3, 43 may be adapted to accommodate handicapped or disabled observers. As shown in FIG. 1, the viewing stations 3, 43 are arranged around (e.g., 360 degrees) a spherical, retro-reflective projection screen 18. Reflected images from beamsplitters located at each of the viewing stations 3, 43, are received by the projection screen 18, and the projection screen 18 reflects the images back towards the beamsplitters. Observers at the viewing stations 3, 43 view 3D images on the projection screen 18 by looking through the beamsplitters. After viewing an image at a particular viewing station, an observer can move to another viewing station to view a different image. For example, the observers can move around the perimeter of the projection screen 18 and they can witness one image fade into the next as they look through beamsplitters at successive viewing stations. Projection screen 18 is indicated as spherical in FIG. 2. However, it is not essential that screen 18 be spherical. In accordance with alternative arrangements shown in FIGS. 9 and 10, the projection system described herein may be equally applied to concave or flat projection screens, 180 and 280 respectively. Accordingly, while the shape of the projection screen can be altered, the principles of the invention remain unchanged and applicable to the screen as configured.

Advantageously, the image being viewed by an observer at one viewing station is not substantially affected by the images being viewed by observers at other viewing locations, because the observers at different stations are not positioned along the same optical axis. When the observers are positioned along different optical axes, they see different images.

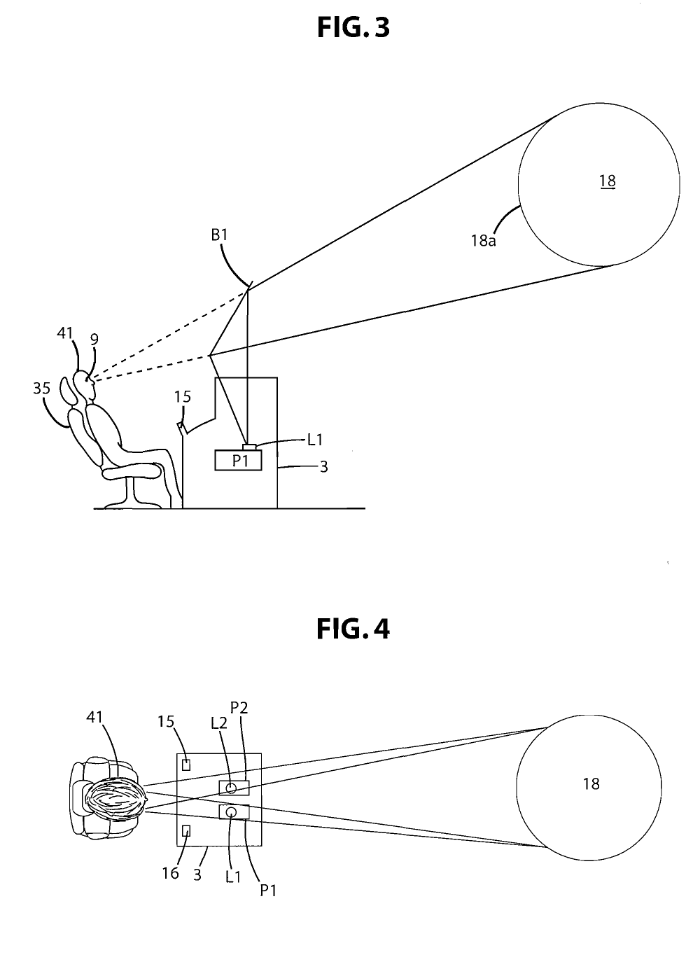

Details of one exemplary viewing station are described with reference to FIGS. 3 and 4. FIG. 3 is a side view which shows the relationship between the projector pair P1 and P2 and the observer's eyes and FIG. 4 shows it from the top. The beamsplitter B1 referenced and described with respect to FIG. 3 has been purposefully omitted in FIG. 4 for purposes of clarity in explanation, however one should assume that the beamsplitter shown in FIG. 3 is in place in the system of FIG. 4. Also, it should be evident that projector P1 and P2 are horizontally aligned as shown in FIG. 3 and if viewed directly from the side one of the projectors would fully block the other from view. The viewing station (housing 3) includes projectors P1 and P2. Projectors P1 and P2 include lens L1 and L2, respectively. Any suitable projector can be used including a video projector or slide projector. For example, the projector may be an LCD or light-valve color projector with a single exit pupil. Housing 3 is preferably located outside of, and below spherical screen 18. Handgrip(s) 15 for optimizing viewing geometries and for controlling any audio output or interactive digital input can be coupled to the housing 3. Handgrips 15 can replaced by joysticks or remote controllers similar to the type used in computer gaming application. Optimizing viewing geometries entails placing the observers eyes in the same optical position as the projection lenses so that the observer can view the image without distortion. As discussed above this can be accomplished by adjusting the observer's physical position (specifically his viewing position) with respect to the projection system or by adjusting the position of the projectors and beamsplitters with respect to observer. While handgrips 15 for adjusting the vertical and/or horizontal position of the projection system with respect to the observer have been disclosed it is preferable that the projection system remain fixed and the observer's position relative thereto be adjusted using an adjustable chair 35 (FIG. 3) which the observer is seated in during viewing.

Each viewing station includes a beamsplitter B1. Beamsplitter B1 is positioned at a predetermined angle and may be coupled to housing 3 using fixed bracket sets. As shown in FIG. 3, beamsplitter B1 is located above projectors P1 and P2 and receives images from the projectors. The images received by beamsplitter B1 are partially reflected to portion 18a of the projection screen 18 (FIG. 4). For each station, the total distance from the protector lens L1/L2, to the beamsplitter B1 to the respective portions 18(a) of the projection screen 18 is between about 4 feet and about 40 feet.

The light exiting the lenses L1 and L2 reflects off the beamsplitter B1 and hits the projection screen 18. Some of the light passes through the beamsplitter and is lost. Screen 18 must be retro-reflective, so the sphere reflects the light exactly back where it came from. Some of that reflected light from the sphere reflects off beamsplitter B1 and goes back into the lens (e.g. it's lost to the system). The portion of light that is not reflected passes through the beamsplitter and converges at a point. This point of convergence is the preferred location for the eye of observer 41. In order to produce a well-defined 3D image, there must be two points of convergence, one for the left eye of the observer and one for his right eye. Hence, there are two projectors with two lenses according to this embodiment.

All beamsplitters used in embodiments of the invention are preferably made of a sheet of glass with a partially reflective layer on one side and an anti-reflective layer on the other. The partially reflective surface may be produced by coating a glass sheet with a silvered material. In some instances, a double reflection can be caused by a second reflection off of the other surface of the glass. Accordingly, it is desirable to coat the other side of the glass sheet with an antireflective material. The use of an anti-reflective coating helps to prevent a double reflection of the image provided by the projector and reduces glare on the beamsplitter from reflecting stray light in the room. In preferred embodiments, the front surface of the beamsplitter is mirrored to reflect approximately 50%-80% of the incident light, while the rear surface of the beamsplitter does not substantially reflect the incident light. Image brightness is optimal with approximately 50% of incident light reflected from the beamsplitter and spill light transmitted through the beamsplitter is optimally minimized with approximately 80% of incident light reflected from the beamsplitter. Also, each of the beamsplitters includes an anti-shattering material to prevent them from shattering when undue pressure is applied, in certain applications.

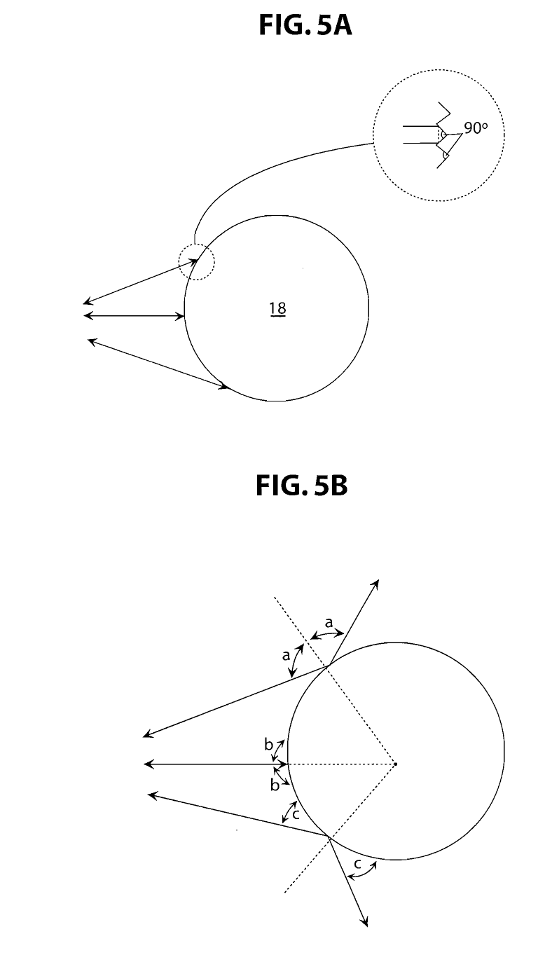

The projection screen 18 used in embodiments of the invention may be spherical, hemispherical, octagonal, cubic, straight, or curved over the projection portion 18a. The screen can be formed from sheets of overlapping material. The projection screen may be made of any suitable material including fiberglass, and must include either a retro-reflective material or a material possessing retro-reflective properties. Suitable retro-reflective materials can be obtained from 3M Corporation. As will be described in further detail below with reference to FIG. 5A, retro-reflective materials are desirable, because they can return light in the direction from which it originates, regardless of the angle of incidence. In preferred embodiments, the projection screen 18 includes self-adhesive sheets of a flexible, retro-reflective material applied to its outer surface. If the sheets are overlapped, overlapping edges are preferably not easily visible to the observer.

The viewing stations 3 may incorporate one or more speakers (not shown) for providing sound (e.g., music, narration) for the observers during viewing, and permit discrete listening for each observer at his or her viewing station. As will be described in more detail below, an observer can control the audio output, digital image output, or image quality at his or her viewing station so that the observer's experience is customized.

An observer 41 at a viewing station 3 can view one or more 3D images on the projection screen portion 18a by looking through beam splitter B1. A mechanical structure 35 (e.g., chair, stool, bench, or elevation device) may be provided at the viewing station 3 to help both taller and shorter observers obtain proper positioning in front of the beamsplitter B1. Taller observers 41 may adjust structure 35 appropriate for their height, while shorter observers, such as children, may stand. The image viewed by the observer 41 is three dimensional.

While the observer 41 at the viewing station 3 views an image on a portion 18a of the projection screen 18, observers at another viewing station may view a different image on substantially the same or another portion of the projection screen. With an appropriately sized screen 18, the images reflected onto the projection screen from respectively different beamsplitters can be spatially separated from each other on the projection screen, and do not optically interfere with each other. Observers at different viewing stations 3 have different viewing axes, and are thus able to view respectively different images simultaneously.

Preferably, the optical geometry between the beamsplitter, the observer's eyes, and the projector lens is optimized to produce a clear and bright 3D image for the observer to see. For example, the position of the observer's eyes are at a position which is substantially along the projection axis at the same distance from the projection surface as the optical center of the projection lens. This relationship can be achieved through the use of the beamsplitter B1 which is placed between the observer and the projection surface, and which allows the physical position of the optical center of the projection lens to be in a reflected position which is substantially in the same optical position as the observer's eye. Preferably, the position of the observer's eyes and the position of the projector lens are substantially symmetrical with respect to the beamsplitter.

Continuing with FIG. 3, the distance between the projector lens L1 and the beamsplitter B1, and the distance between the observer's eyes 9 and the beamsplitter are preferably substantially equal. For instance, the distance between the beamsplitter B1 surface and the lens L1 which produces the image is preferably between 2 to 3 feet, while the distance between the optical image on the beamsplitter B1 and the eye 9 of the observer can also be 2 to 3 feet. Also, the angle formed by a light beam from the projector lens L1 and the beamsplitter B1, and the angle formed by the viewing axis and the beamsplitter are preferably substantially equal.

A mechanical apparatus can be used to obtain the optimum optical geometry for viewing images. For example, in some embodiment, the mechanical apparatus may move one or more of the beamsplitter, the observer, and/or the projector lens to arrive at the optimal optical geometry to provide the observer with a distortionless, optically brilliant image to view. Alternatively or additionally, the mechanical apparatus includes steps, a chair or an incline so that observers can move to an optimal viewing position. Preferably, the observer can operate and manipulate the mechanical apparatus using his or her hands. For example, the mechanical apparatus can include a pair of handgrips 15. The handgrips 15 may be operated by the observer and may be used to move the observer, projector lens (e.g., by moving the projector) and/or the beamsplitter to achieve the optimal viewing geometry for the observer. In some embodiments, the observer can move himself or herself horizontally, vertically, or diagonally to an appropriate viewing position using the handgrips 15. Alternatively, and in a preferred embodiment, an adjustable chair 35 is provided for adjusting the vertical position of the observer with respect to the beamsplitter, thereby placing the observer in an optimal position to view the images.

The viewing stations may also include other features for the observers to control. For example, in those embodiments using handgrips, the handgrips (or other device) may be used to control the sound or images seen by the observer. For instance, an observer may stop, rewind, or fast forward a soundtrack and/or images using the handgrips 15. In addition, the handgrips 15 can be used for navigation through a menu (e.g., a viewing or audio menu), and can be used to adjust or select any audio output at the viewing station. The handgrips 15 can also include a trigger or button at the ends (similar to a joystick in a video game) for observer input.

FIG. 4 is a top view of the exemplary viewing station shown in FIG. 3. As mentioned above, the beamsplitter B1 referenced and described with respect to FIG. 3 has been purposefully omitted in FIG. 4 for purposes of clarity in explanation, however one should assume that the beamsplitter shown in FIG. 3 is in place in the system of FIG. 4. Projectors P1 and P2 rest beneath beamsplitter B1 and are preferably aligned in such a manner that their lens L1 and L2 are spaced apart a distance equal to the inter-ocular distance of an average observer's eyes. As used in this specification, an inter-ocular distance means about 2½ inches apart to about 3½ inches apart, most preferably 2⅝ inches apart. Projectors P1 and P2 simultaneously project an image pair through beamsplitter B1 and onto screen 18 resulting in a 3D effect when viewed by the observer. The image pair consists of a pair of images, each shot from a slightly different axis. Arranging projectors P1 and P2 side by side such that their lens centers can be physically placed opposite each other at a distance matching that of the observer's eyes (the inter-ocular distance or typically about 2⅝ inches for the average person) is ideal. It is not necessary that the lenses be exactly the distance apart of a particular observer's eyes, because the image produced by the lens closest in optical position to each eye will be the brightest and there is some tolerance in the system. However, the closer it is in practice, the more pronounced and immediate the effect of 3-D will be.

FIG. 5A shows how light is reflected from the screen 18 when a retro-reflective surface is applied to its surface. The magnified portion shows how the surface works. Under magnification the retro-reflective surface has at least two reflections in accordance with Snell's law of reflection that bounce light effectively back to its source. FIG. 5B shows how light would reflect from a normally-reflective surface.

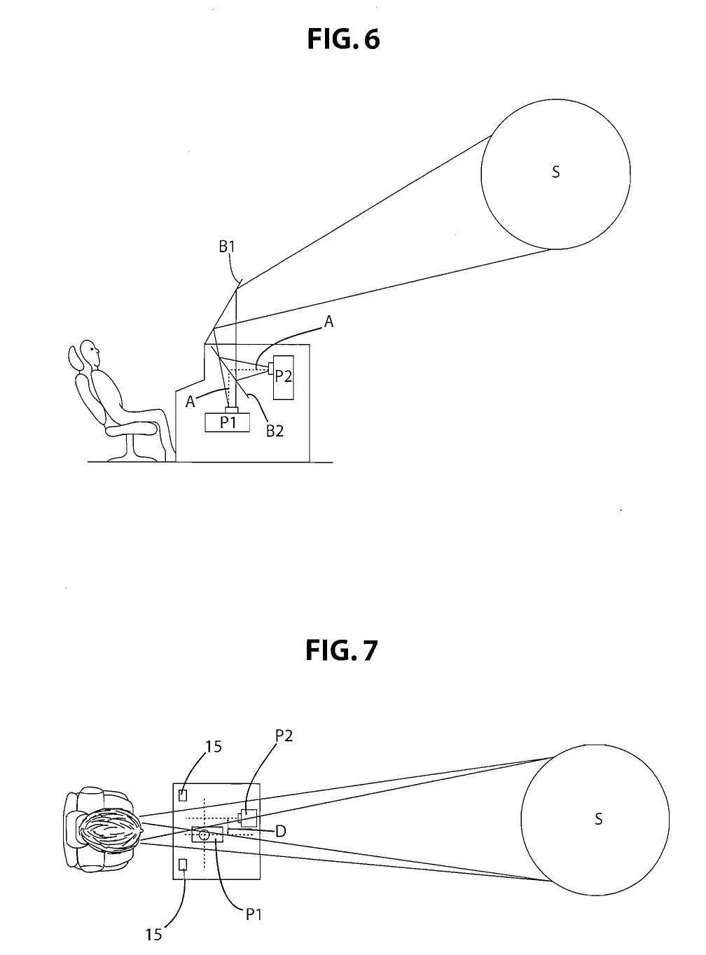

The system described above assumes that the projector bodies and the lenses themselves are small enough to be able to sit proximate each other at the desired lens spacing. Referring to FIG. 6, a second embodiment of the present invention is shown in which the lens centers of projectors P1 and P2 cannot be physically spaced at the desired inter-ocular distance, for example, because the projectors (or lenses) are physically too large to be placed with lens centers the inter-ocular distance apart. In this case, a second beamsplitter B2 is placed between projectors P1 and P2 and beamsplitter B1 to optically superimpose them the correct distance apart. Referring to FIG. 7, the top view shows the lens of projector P1 pointing directly upward through the beamsplitters B1 and B2. The lens of Projector P2 points horizontal, such that light reflected by beamsplitter B2 is positioned at a desired inter-ocular distance. The beamsplitters B1 and B2 in FIG. 6 have been purposefully omitted in FIG. 7 for purposes of clarity in explanation, however one should assume that the beamsplitters shown in FIG. 6 are in place in the system of FIG. 7. To project a meaningful 3D image projectors P1 and P2 should be arranged as follows: the light output from projector P2 which is reflected off of beamsplitter B2 must be at the desired inter-ocular distance (horizontally aligned) from the light output from projector P1 which passes through beamsplitter B2 and they must be in direct vertical alignment (e.g. the same distance from the projection surface). Additionally, beamsplitter B2 is preferably a 50/50 beamsplitter so that the light output from projector P1 is no more, or less, altered then light output from projector P2 when both images pass through beamsplitter B2.

In accordance with an alternative arrangement of the present invention, a single projector P can be employed in conjunction with a software program controlling its input and/or output. In one instance, the projector includes first and second outputs to a lens L directed at the beamsplitter. A source material necessary to drive the first and second projector outputs is preferably captured from two vantage points spaced from one another at the inter-ocular distance of an observer. The software program operates to provide swapped sources for output on the projector lens by controlling the signal input to the projector swapping between first and second projector outputs.

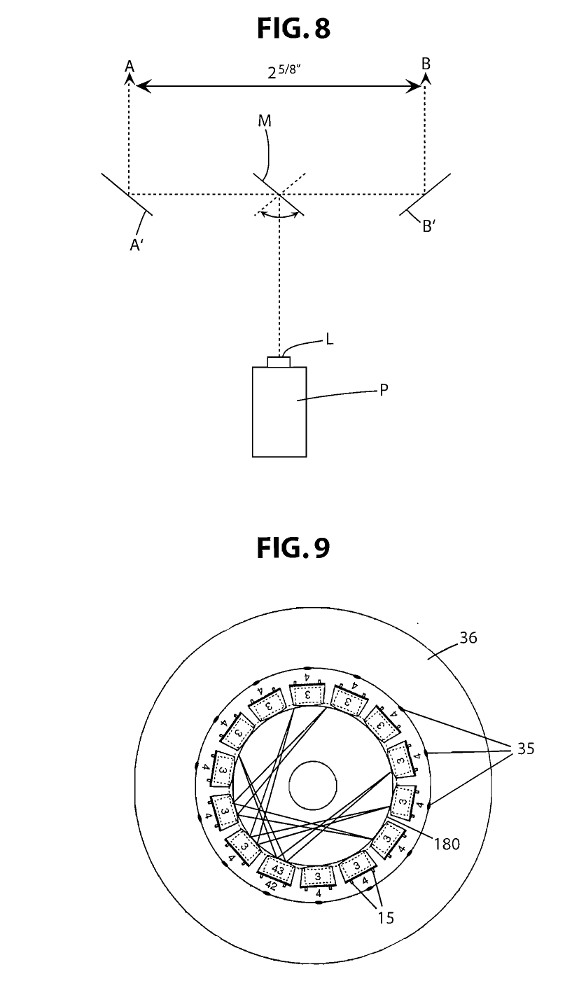

Rather than having multiple outputs, the projector P can have a single output to a lens L and the software program steers the projector output to strike the screen from alternating, spaced locations toward the screen 18a, with the spaced locations being spaced at the inter-ocular distance. In this case, the software program controls a steering mechanism. With reference to FIG. 8, Such a steering mechanism preferably includes a mirror M connected to a vacillating platform and additional mirrors A′ and B′ that directs the projector's beam from the spaced locations at a prescribed frequency. The distance between the reflected locations from which the images originate must be at the inter-ocular distance, e.g. 2⅝ inches.

It is to be understood that this invention is not limited to those precise embodiments and modifications, and that other modifications and variations may be affected by one skilled in the art without departing from the spirit and scope of the invention as defined by the appended claims. Moreover, any one or more features of any embodiment of the invention may be combined with any one or more other features of any other embodiment of the invention, without departing from the scope of the invention.

We claim:

1. A 3D optical projection system comprising:
a projection screen; and
a plurality of viewing stations, wherein each viewing station includes:
a beamsplitter,
a projector including a lens directed at the beamsplitter so as to provide an image on the projection screen,
a software program controlling the input to the projector and providing swapped sources for output on the projector, and
a mechanical apparatus adapted to optimize a quality of an image on the projection screen as seen by an observer looking at the beamsplitter, wherein projectors at different viewing stations are positioned to project different images onto the projection screen.

2. The 3D optical projection system of claim 1 wherein the software program provides swapped sources are at 60 frames/sec or faster.

3. A 3D optical projection system comprising:
a projection screen; and
a plurality of viewing stations, wherein each viewing station includes
a beamsplitter,
first and second projectors each having a lens, wherein the first and second projectors are mounted such that their respective lenses are spaced a distance apart equal to an inter-ocular spacing, wherein the lenses are directed at the beamsplitter and the first and second projectors are configured to project images onto the projection screen, and
a mechanical apparatus adapted to optimize a quality of an image on the projection screen as seen by an observer looking at the second beamsplitter.

4. A 3D optical projection system comprising:
a projection screen; and
a plurality of viewing stations, wherein each viewing station includes:
first and second beamsplitters,
first and second projectors each including a lens, wherein the first and second projectors are directed at the first beamsplitter and configured to project images onto the projection screen through the second beamsplitter, wherein the lenses are optically spaced apart from each other a distance equal to an inter-ocular spacing.
a mechanical apparatus adapted to optimize a quality of an image on the projection screen as seen by an observer looking through the second beamsplitter.

5. The 3D optical projection system of claim 1 wherein the projection screen is shaped as a sphere portion, and wherein the viewing stations are disposed around the projection screen.

6. The 3D optical projection system of claim 4 wherein, at each viewing station, the first and second projectors project an image to the first beamsplitter which partially reflects the image to the second beamsplitter which partially reflects the image to a portion of the projection screen opposite the second beamsplitter.

7. The 3D optical projection system of claim 4 wherein the first and second projectors at different viewing stations are positioned to project different images onto the projection screen.

8. The 3D optical projection system of claim 1 wherein the projection screen comprises a retroflective material.

9. The 3D optical projection system of claim 4 wherein the projection screen is shaped as a sphere portion.

10. The 3D optical projection system of claim 1 wherein the mechanical apparatus comprises steps or an incline.

11. The 3D optical projection system of claim 1 wherein the mechanical apparatus comprises at least one handgrip.

12. The 3D optical projection system of claim 1 wherein the projection screen is formed from overlapping sheets of a material.

13. The 3D optical projection system of claim 1 wherein the mechanical apparatus is capable of being controlled by the observer.

14. The 3D optical projection system of claim 4 wherein the first and second beamsplitters are located between the projector and the observer.

15. The 3D optical projection system of claim 4 wherein a distance between the observer's eyes and the first beamsplitter is approximately equal to a distance between the first beamsplitter and the first projector lens.

16. The 3D optical projection system of claim 1, wherein each viewing station further comprises a speaker.

17. The 3D optical projection system of claim 1 wherein the mechanical apparatus includes an elevation device upon which the observer is disposed.

18. The 3D optical projection system of claim 4 wherein the first and second beamsplitters include an anti-reflective coating.

19. The 3D optical projection system of claim 4 wherein the first and second beamsplitters comprise a glass sheet coated with an anti-reflective material on a first side of the glass sheet and a reflective material on the second side of the glass sheet.

20. The 3D optical projection system of claim 1 wherein the mechanical apparatus is adapted to move the observer, the first beamsplitter or the projector.

21. The 3D optical projection system of claim 4 wherein the first and second projectors simultaneously project the images onto the projection screen.

22. A 3D optical projection system comprising:
a projection screen; and
a plurality of viewing stations, wherein each viewing station includes:
a beamsplitter,
a projector with first and second outputs, the projector including a lens directed at the beamsplitter,
a source material driving the first and second projector outputs, wherein the source material is captured from two vantage points spaced from one another at an inter-ocular distance;
a software program controlling the input to the projector and swapping between first and second projector outputs, and
a mechanical apparatus adapted to optimize a quality of an image on the projection screen as seen by an observer looking at the beamsplitter,
wherein projectors at different viewing stations are positioned to project different images onto the projection screen.

23. The 3D optical projection system as in claim 3 wherein the first and second projectors are configured to project respective images which were taken at an inter-ocular distance apart onto the projection screen.

24. The 3D optical projection system as in claim 3 wherein the images are superimposed at a focal distance which is viewable by the observer looking through the second beamsplitter.
